(19) United States
(12) Patent Application Publication
(10) Pub. No.: US 2018/0315094 A1
(43) Pub. Date: Nov. 1, 2018

(54) METHOD AND SYSTEM FOR TARGETED ADVERTISING BASED ON NATURAL LANGUAGE ANALYTICS

(71) Applicant: International Business Machines Corporation, Armonk, NY (US)

(72) Inventors: Maryam Ashoori, White Plains, NY (US); Benjamin D. Briggs, Waterford, NY (US); Lawrence A. Clevenger, Rhinebeck, NY (US); Leigh Anne H. Clevenger, Rhinebeck, NY (US); Michael Rizzolo, Albany, NY (US)

(21) Appl. No.: 15/825,757

(22) Filed: Nov. 29, 2017

Related U.S. Application Data
(63) Continuation of application No. 15/583,221, filed on May 1, 2017.

(51) Int. Cl. G06Q 30/02; G10L 15/04; G10L 17/22; G10L 15/02; G10L 15/18; G10L 17/00

(52) U.S. Cl. CPC G06Q 30/0269; G10L 15/04; G10L 17/22; G10L 17/005; G10L 15/02; G10L 15/1815

(57) ABSTRACT

A computer implemented method and system for identifying advertisements targeted to individuals based on analysis of audio recordings. The method includes recording audio input from at least one media transmission, analyzing the recorded media audio to identify content of the at least one media transmission, recording audio input from at least one individual, analyzing the recorded individual audio to classify the at least one individual into at least one segment, analyzing the recorded individual audio to identify at least one sentiment related to the identified media content, analyzing the at least one sentiment in context with the identified media content and identifying at least one advertisement targeted to the at least one segment based on the contextual analysis.

### BACKGROUND

The present invention is relates to computers and more particularly to computer-implemented methods, computer program product and systems associating advertisements with individuals based on analysis of audio recordings.

Advertisers typically develop advertising campaigns targeted to blanket a large audience of existing or potential customers of the advertised good or service. The campaigns are often static and cannot be targeted to specific customers. As a result, advertisers desire to provide relevant advertising to large group of potential customers. However, existing solutions do not provide for real-time data collection and analysis to provide dynamic, targeted content. Existing solutions also do not identify in real-time content to be presented according to real-time data collection. Real-time viewer sentiment and verbal reaction to media exposure is not taken into consideration when determining advertisements to display to consumers. The lack of real-time consumer feedback is a drawback of the typical consumer rating service.

### SUMMARY

One embodiment of the present invention is a computer implemented method for identifying advertisements targeted to individuals based on analysis of audio recordings that includes: recording audio input from at least one media transmission, analyzing the recorded media audio to identify content of the at least one media transmission, recording audio input from at least one individual, analyzing the recorded individual audio to classify the at least one individual into at least one segment, analyzing the recorded individual audio to identify at least one sentiment related to the identified media content, analyzing the at least one sentiment in context with the identified media content and identifying at least one advertisement targeted to the at least one segment based on the contextual analysis.

Other embodiments include a computer program product and a system.

### BRIEF DESCRIPTION OF THE DRAWINGS

Further features as well as the structure and operation of various embodiments are described in detail below with reference to the accompanying drawings, in which like reference numbers indicate identical or functionally similar elements and wherein:

FIG. 1 depicts one embodiment of a system in accordance with the present invention.

FIG. 2 depicts one embodiment of a method in accordance with the present invention.

FIG. 3 depicts one embodiment of a cloud computing environment in accordance with the present invention.

FIG. 4 depicts one embodiment of abstraction model layers in accordance with the present invention.

FIG. 5 depicts an exemplary computing system in accordance with the present invention.

### DETAILED DESCRIPTION

This invention includes embodiments directed to a computer implemented method and computer system for identifying advertisements targeted to individuals based on analysis of audio recordings. By way of overview only, in some embodiments, audio from one or more media transmissions, such as, broadcast media, live or on-demand, and ambient comments by one or more individuals in reaction to the media transmission are recorded by an audio recording device, such as, one or more “always listening” devices. A few non-limiting examples of such “always listening” devices can include a smartphone or an intelligent voice-control device. Analysis of the recorded media audio can identify content of the media transmission and analysis of the recorded individual audio can identify the individual and/or classify the individual into a segment, such as a demographic segment. Other non-limiting examples of a segment include geographic, usage-based, behavioral and psychographic. Sentiment analysis can also be performed on recorded individual audio to identify sentiment related to the identified media content. The sentiment is analyzed in context with the identified media content to identify advertisements targeted to one or more individuals or segments e.g., demographic segment(s), based on the contextual analysis. The targeted advertisement identification is made without any consumer input other than their natural responses. Some embodiments of the present invention improve over prior art targeted advertisement systems by reflecting customer sentiment (such as customer tone) and/or through natural language processing to build a marketing profile specifically for a customer without additional user input.

An optional user profile may also contribute to a targeted advertisement decision. Targeted advertisements can be output to consumers based on the analysis. The targeted ads may be displayed on any consumer devices, such as (without limitation), television, smartphone, smart watch, and/or other portable or mobile devices having a capability to receive the transmission of the ads.

In some embodiments, the audio input is recorded using an always-on listening and recording device. In some embodiments, an intelligent voice-control device is used. Microphones from other devices can also be included. In some embodiments, the device listens for select advertising, identifies the selected advertisement, then starts recording customers' reactions. In some embodiments, the device listens for broadcast media, identifies the program, then starts recording customers' reactions. By listening and identifying advertisements or other broadcast media through audio waveforms, such as voice and music waveforms, the method and system of this invention can track media and advertisements across many platforms, including internet, television, radio, and other platforms on which media is or becomes available.

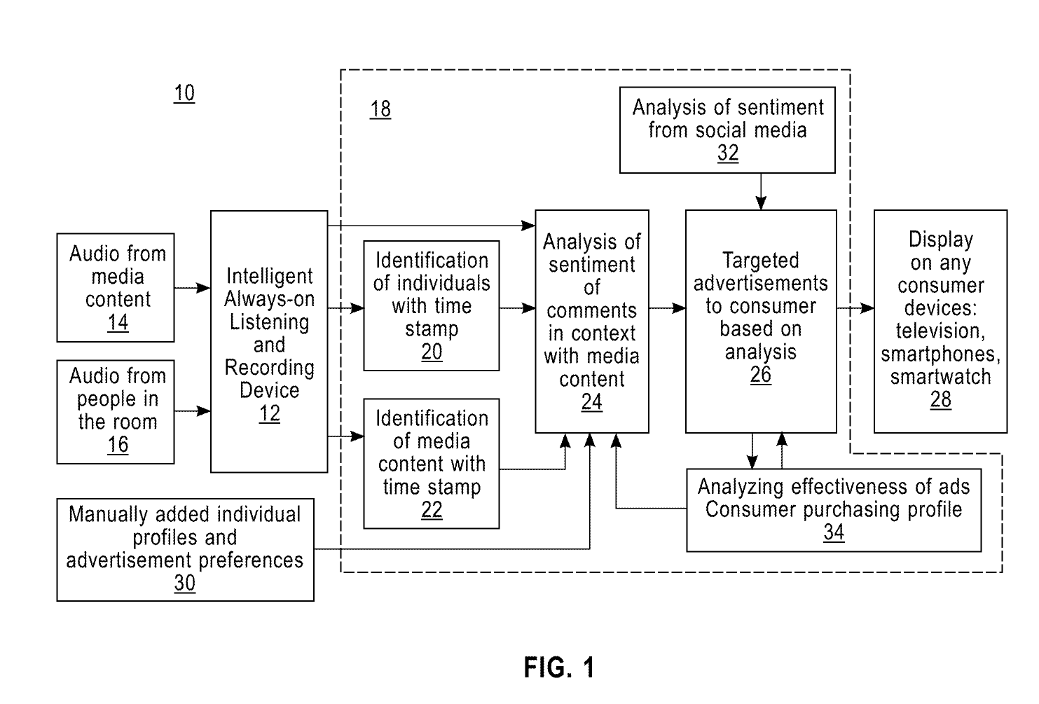

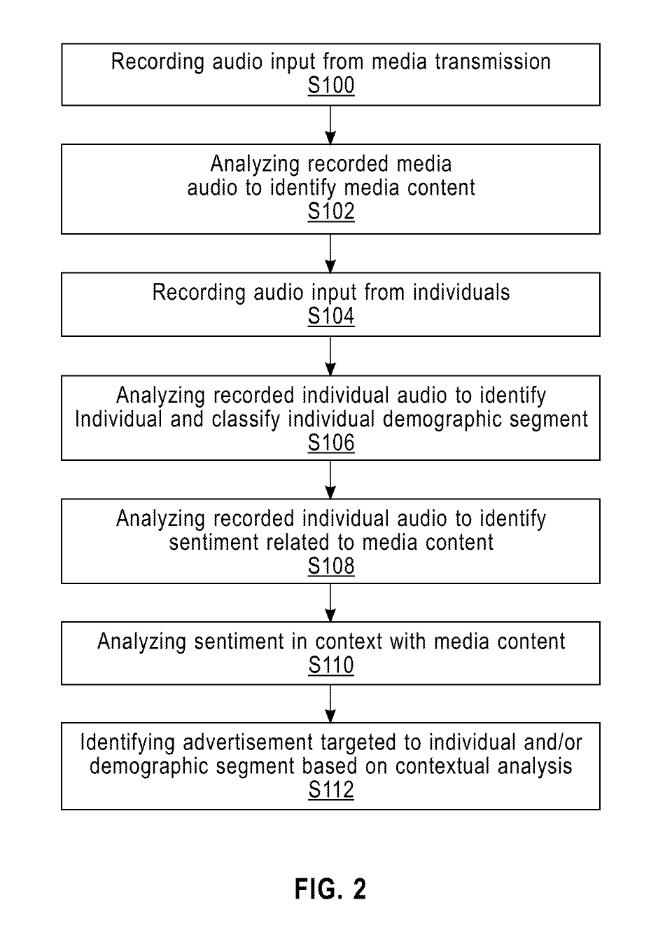

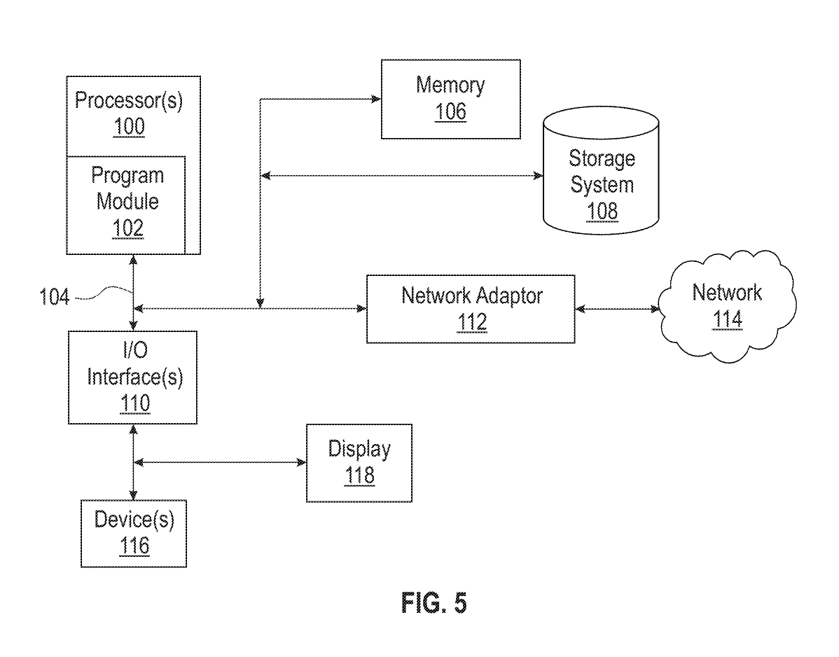

FIG. 1 is a block diagram of one embodiment of a system for associating advertisements with individuals based on analysis of audio recordings. An exemplary computer system, including one or more computer processors and computer readable memory will be described with reference to FIG. 5. One (non-limiting) example of such computer readable memory includes computer-readable storage media, with computer program instructions stored thereon. Execution of the program instructions by the one or more processors causes the computer system to perform a method in accordance with the present invention. An exemplary method will be described in more detail with reference to FIG. 2.

Referring now to the embodiment depicted in FIG. 1, an intelligent always-on listening and recording device 12 located in a room receives input of audio 14 from media content from at least one media transmission being played in the room and audio 16 (e.g., ambient content) associated with at least one individual speaking in the room. Listening device 12 records the audio input from the at least one media transmission and records the audio input from the at least one individual. Listening device 12 optionally places a time stamp on each recording.

Program module 18, which is also shown as program module 102 in FIG. 5, contains a plurality of program instruction modules. In some embodiments, module 20 analyzes the recorded individual audio to classify the at least one individual into at least one demographic segment. In some embodiments, module 20 also analyzes the recorded individual audio to identify the at least one individual. Module 20 optionally includes the time stamp with the identification of the individual. Module 22 analyzes the recorded media audio to identify the content of the at least one media transmission. Module 22 optionally includes the time stamp with the identification of the content. Module 24 analyzes the recorded individual audio to identify at least one sentiment related to the identified media content. Module 24 also analyzes the at least one sentiment in context with the identified media content. Module 26 identifies at least one advertisement targeted to at least one of the at least one individuals based on the contextual analysis. Module 26 also identifies at least one advertisement targeted to the at least one demographic segment based on the contextual analysis. The targeted advertisements are then outputted to a display 28 of a consumer device, such as television, smartphone, smartwatch, etc.

In some embodiments, the analysis by Module 24 of the recorded individual audio to identify at least one sentiment related to the identified media content is enhanced by individual profiles and advertisement preferences 30 that are manually added to module 24. In some embodiments, module 32 performs sentiment analysis from social media posts related to the media content. In this embodiment, module 26 identifies the at least one advertisement targeted to at least one of the at least one individuals based on the contextual analysis from module 24 enhanced by the contextual analysis from social media from module 32. Module 34 in some embodiments develops a consumer purchasing profile that can be used to further enhance the identification of a targeted advertisement by module 26. In another embodiment, module 34 analyzes the effectiveness of the identified advertisements based on consumer purchasing in response to the advertisements. The effectiveness of advertisements can be tracked through a consumer purchasing profile and discovery of community actions.

FIG. 2 is a flow chart of the one embodiment of a computer implemented method for identifying advertisements targeted to individuals based on analysis of audio recordings. The method shown in FIG. 2 includes step 100 recording audio input from media transmissions, step S102 analyzing recorded media audio to identify media content, step S104 recording audio input from individuals and step S106 analyzing recorded individual audio to identify individuals and classify individual demographic segments. The method shown in FIG. 2 further includes step S108 analyzing recorded individual audio to identify sentiment related to media content, step S110 analyzing sentiment in context with media content and step S112 identifying advertisement targeted to individual and/or demographic segment based on contextual analysis.

In some embodiments, the recording and analyzing steps are performed in real time for identifying the at least one targeted advertisement based on real time verbal reactions of the individuals. Thus, the method according to this embodiment overcomes a major drawback of the typical consumer rating services and other like services. In some embodiments, the module 24 performs within step S110 storing the sentiment data obtained from the sentiment analysis, and storing the contextual data obtained from the contextual analysis. Module 26 can perform within step S112 refining future targeted advertisements based on the stored sentiment and contextual data.

In some embodiments, the computer implemented method includes the listening device 12 performing within steps S100 and S104 listening for media audio and individual audio using an always-on audio recording device and monitoring the always-on audio recording device at regular intervals to determine whether the media transmission is active.

In some embodiments, module 20 performs within step S106 using voice recognition to identify the individual and module 22 performs within step S102 uses natural language analytics to identify the content of the media transmission. In some embodiments, module 24 performs within step S108 using psycholinguistics to identify sentiment of the individual.

In some embodiments, the computer implemented method of claim 1 further comprising analyzing sentiments from a plurality of individuals to determine an overall sentiment.

In some embodiments, step S110 includes analyzing social media associated with the media transmission content and enhancing the analysis of the sentiment based on the social media analysis.

In some embodiments, the analysis steps S102, S106, S108 and S110 use voice/speech recognition and speaker recognition. Speaker recognition can be applied to differentiate between one person talking and the other voices in an environment, using a digital representation of one's unique vocal features. Live broadcast content and on-demand content is identified by recognition of media audio content. In some embodiments, if the listening device 12 device is intelligent device used to control the playing of the media (i.e. saying “play the movie [Title] on my TV”), then subsequent audio recordings don't need to identify the media content. Instead, they just are assigning a timestamp within the movie to attribute reactions of the users in the room.

The listening device 12 “listens” for media content by recording the audio from the media transmissions and module 22 performing speech recognition using speech to text natural language analytics (NLA) software to identify the content. Speech recognition software converts speech to text to provide speech transcription capability. To transcribe the human voice accurately, the speech to text software leverages machine intelligence to combine information about grammar and language structure with knowledge of the composition of the audio signal. The software continuously returns and retroactively updates the transcription as more speech is heard. Once the audio form the media transmission is converted to text, the system analyzes the text to identify the content, by for example, a particular movie, TV show, music video, product advertisement, etc. The media transmission includes one or more of broadcast media, streaming media and pre-recorded media.

The listening device 12 “listens” for individual comments by module 20 using speaker recognition for the identification of a person from characteristics of voices, also known as voice biometrics. Recognizing the speaker includes the task of translating speech in systems that have been trained on specific person's voices. Speaker identification is a 1: N match where the voice is compared against N templates. Speaker recognition system may have two phases: enrollment and verification. During enrollment, the speaker's voice is recorded and typically a number of features are extracted to form a voice print, template, or model. In text independent systems both acoustics and speech analysis techniques are used. Speaker recognition is a pattern recognition problem. The various technologies used to process and store voice prints include frequency estimation, hidden Markov models, Gaussian mixture models, pattern matching algorithms, neural networks, matrix representation, Vector Quantization and decision trees. Ambient noise levels can impede both collections of the initial and subsequent voice samples. Noise reduction algorithms can be employed to improve accuracy. Signal processing distinguishes between sounds that matter and those that do not, and voice biometrics helps determine who is speaking.

In some embodiments, multi-microphone arrays can dynamically steer “listening beams,” which, with the aid of video cameras, can track the location of the individual. Mobile listening devices are aware of the user and his or her context, and are thus more discriminating. Such interactions will be tied together through a framework of client and cloud based recognizers and NLA engines. The user's interaction history will be aggregated in the cloud, used to improve recognition models that will be pushed out to all listening devices. In some embodiments, the sentiment data and the contextual data are stored on the cloud and the identification of future targeted advertisement is refined based on the sentiment and contextual data stored on the cloud. In addition, the method and system can reuse data stored on the cloud to inform future analyses. The data collected from the user through speech to text conversion is used to build a predictive but also re-active model to enhance and improve the advertiser/user experience. In addition, the method and system can write and save snippets from the recordings, such as, sentiment plus quotes, and make them available commercially to marketers.

In some embodiments, sentiment analysis uses natural language analytics, text analysis, computational linguistics, and biometrics to systematically identify, extract, quantify, and study affective states and subjective information. Sentiment analysis aims to determine the attitude of a speaker with respect to some topic or the overall contextual polarity or emotional reaction to an event. The attitude may be a judgment or evaluation, the emotional state of the speaker, or the intended emotional communication. Software tools deploy machine learning, statistics, and natural language processing techniques to automate sentiment analysis.

In some embodiments, sentiment analysis is performed by the IBM Watson Tone Analyzer™ service. Sentiment analysis refers to the use of natural language processing, text analysis, computational linguistics, and biometrics to systematically identify, extract, quantify, and study affective states and subjective information. Relying on the scientific findings from psycholinguistics research, the Tone Analyzer™ infers people's personality characteristics, their thinking and writing styles, their emotions, and their intrinsic needs and values from text. The Tone Analyzer™ learns various features from text and puts them to work in machine learning models. Research has shown a strong and statistically significant correlation between word choices and personality, emotions, attitudes, intrinsic needs, values, and thought processes. Several researchers found that people vary in how often they use certain categories of words when writing for blogs, essays, and tweets and that these communication mediums can help predict aspects of personality.

The Tone Analyzer™ service analyzes real-time input from commercials, other broadcast media, and ambient comments from individual consumers who are present in an environment. Tone Analyzer™ emotions identified include anger, fear, joy, sadness, and disgust, along with the percentage of each. The Tone Analyzer™ identifies social tendencies, including openness, conscientiousness, extroversion, agreeableness, and emotional range, as interpreted by text analysis. Identified emotions can be expanded and/or customized using a natural language classifier.

Some embodiments include an analysis of an overall sentiment of comments, whether positive, negative, or no feedback. The analysis of an overall sentiment of comments can be from the individual and also from others. For example, comments from all persons in a room can be analyzed and catalogued without necessarily knowing their identity. Tags would be applied to the stored sentiment comments if immediate identification of the individual was not possible. The tags can be correlated with future content to allow past comments to be retroactively attributed to an individual. The tagging of comments can include confidence intervals in the algorithm to attribute to specific individuals or segments. Even without individual attribution, demographic assumptions can be made to feed to external marketers.

Some embodiments supplement the sentiment analysis based on social media information associated with the broadcast media. For example, social media posts can be by the individual or can include posts from others. If the system is able to identify the individual, the social media posts would be tagged to that specific person. Some embodiments would identify the demographic (i.e. one of several teenagers in a household, male, etc) and link social media posts from the household teenagers to that marketing profile. In some embodiments, the social media information is combined with a user profile to display targeted future advertisements to individual consumers and analyze effectiveness of prior advertising.

It is to be understood that although this detailed description includes an example in a cloud computing environment, implementation of the teachings recited herein are not limited to a cloud computing environment. Rather, embodiments of the present invention are capable of being implemented in conjunction with any type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

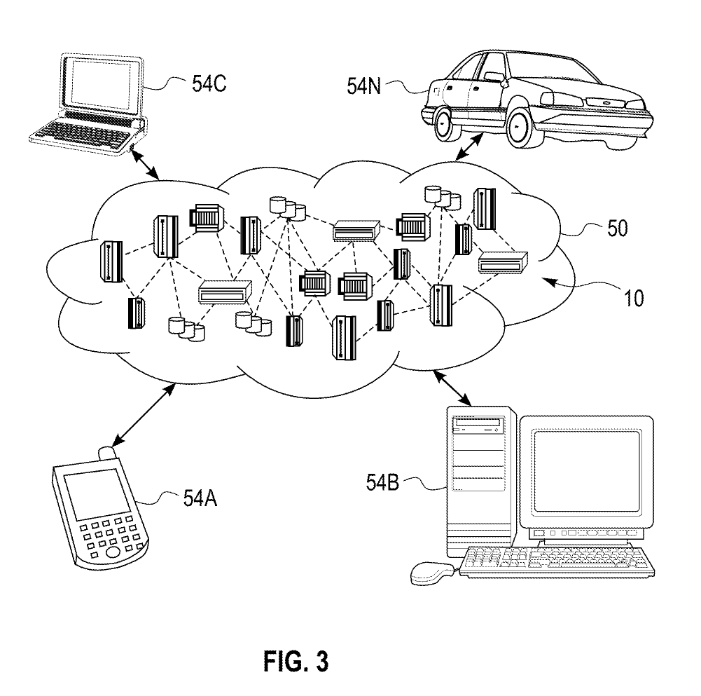

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

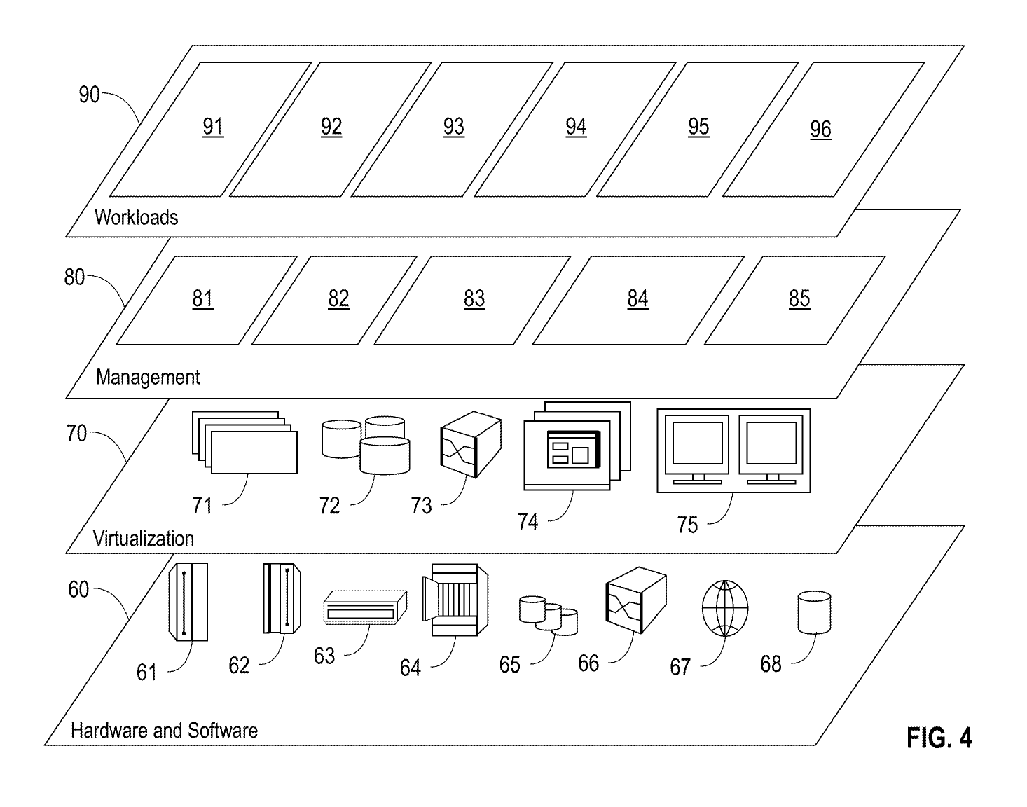

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and module 96 for identifying advertisements targeted to individuals based on analysis of audio recordings.

FIG. 5 illustrates a schematic of an example computer system that may implement the method for identifying advertisements targeted to individuals based on analysis of audio recordings in one embodiment of the present invention. The computer system is only one example of a suitable system and is not intended to suggest any limitation as to the scope of use or functionality of embodiments of the present invention. The system shown may be operational with numerous other general purpose or special purpose computing system environments or configurations. Examples of well-known computing systems, environments, and/or configurations that may be suitable for use with the system shown in FIG. 5 may include, but are not limited to: mobile devices, handheld devices, wearable devices, laptop devices, thin clients, thick clients, personal computer systems, server computer systems, client computer systems, peer-to-peer computer systems, systems of networks, multiprocessor systems, microprocessor-based systems, set top boxes, programmable consumer electronics, network PCs, minicomputer systems, and/or mainframe computer systems, including networked and distributed cloud computing environments that include any of the above systems or devices, and the like.

The system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs one or more features or functions in accordance with the present invention e.g., described with reference to FIG. 1 and/or FIG. 2. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a non-transitory computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for analysis of audio recordings comprising:
recording audio input from at least one media transmission;
analyzing the recorded media audio to identify content of the at least one media transmission;
recording audio input from at least one individual;
analyzing the recorded individual audio to classify the at least one individual into at least one segment;
analyzing the recorded individual audio to identify at least one sentiment related to the identified media content;
analyzing the at least one sentiment in context with the identified media content; and
identifying at least one advertisement targeted to the at least one segment based on the contextual analysis.

2. The computer implemented method of claim 1, wherein each of the recording and analyzing steps are performed in real time for identifying the at least one targeted advertisement based on real time verbal reaction of the at least one individual.

3. The computer implemented method of claim 1, further comprising storing sentiment data obtained from the sentiment analysis, storing contextual data obtained from the contextual analysis and refining at least one future targeted advertisement based on the stored sentiment and contextual data.

4. The computer implemented method of claim 1, further comprising listening for media audio and individual audio using an always-on audio recording device and monitoring the always-on audio recording device to determine whether the media transmission is active.

5. The computer implemented method of claim 1, further comprising analyzing the recorded individual audio to identify the at least one individual for identifying at least one advertisement targeted to the at least one individual, and using voice recognition to identify the individual, using natural language analytics to identify the content of the media transmission and using psycholinguistics to identify sentiment of the individual.

6. The computer implemented method of claim 1, wherein the at least one individual is classified into at least one demographic segment based on the analysis of the recorded individual audio.

7. The computer implemented method of claim 1, further comprising analyzing social media associated with the media transmission content and enhancing the analysis of the sentiment based on the social media analysis.

8. The computer implemented method of claim 3, further including storing the sentiment data and storing contextual data in a cloud environment and refining at least one future targeted advertisement based on the sentiment and contextual data stored in the cloud environment.
